(19) United States
(12) Patent Application Publication
(10) Pub. No.: US 2006/0099002 A1
(43) Pub. Date: May 11, 2006

(54) Fixing unit, image forming apparatus including the same, and method of controlling the fixing unit

(76) Inventor: Yong-kwon Kim, Cheonan-si (KR)

Correspondence Address: STANZIONE & KIM, LLP, 919 18TH STREET, N.W., SUITE 440, WASHINGTON, DC, 20006, US

(21) Appl. No.: 11/168,396

(22) Filed: Jun. 29, 2005

(30) Foreign Application Priority Data
Nov. 10, 2004 (KR) 2004-91494

(51) Int. Cl. G03G 15/20; G03G 15/00

(52) U.S. Cl. 399/69; 399/12

(57) ABSTRACT

A fixing unit, an image forming apparatus including the same, and a method of controlling the fixing unit are provided. The fixing unit includes a heating element to apply heat to a printing medium to fix a transferred image thereon, a temperature sensor to sense temperature of the heating element, and a storage medium to store characteristic data of the heating element. The image forming apparatus includes the fixing unit and a controller to read the characteristic data of the heating element and to determine a control mode of the fixing unit based on the characteristic data of the heating element. The method of controlling the fixing unit includes accessing the fixing unit and reading the characteristic data of the heating element from the storage medium, and setting a control mode of the fixing unit based on the characteristic data of the heating element.

### CROSS-REFERENCE TO RELATED APPLICATIONS

This application claims the priority under 35 U.S.C. § 119 of Korean Patent Application No. 2004-91494, filed on Nov. 10, 2004, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to a fixing unit that fixes an image to a printing medium, an image forming apparatus including the same, and a method of controlling the fixing unit.

2. Description of the Related Art

An image forming apparatus is usually equipment, such as a printer or a copy machine, that prints images on a printing paper and includes a printing unit to print images. The printing unit includes a fixing unit that fixes an image to a printing paper using heat.

Fixing units can be largely classified into halogen lamp type fixing units, hot-wire type fixing units, and induction heater (IH) type fixing units according to a type of heating element. Fixing units classified into the same category can be further subdivided according to diverse factors, such as the amount of heat generated by a heating element, the size of the heating element, and the consumption power of the heating element. Image fixing characteristics may vary with a type of fixing unit.

Conventionally, a fixing unit included in an image forming apparatus can be replaced with the same type of fixing unit, but not with a different type of fixing unit. This is because the image forming apparatus is fixed to a control mode suitable to a fixing unit initially installed therein, and thereby cannot control a different type of fixing unit. When considering that preheating speed, fixing temperature, consumption power, etc. may be different according to a type of fixing unit, not allowing change of a type of fixing unit limits options of a user of an image forming apparatus. Moreover, if a user cannot purchase the same type of fixing unit as that initially installed in an image forming apparatus due to sold-out or out-of-stock situations, the image forming apparatus cannot be used any more.

### SUMMARY OF THE INVENTION

The present general inventive concept provides a fixing unit to store recorded characteristics of a heating element.

The present general inventive concept also provides a method and image forming apparatus to control a fixing unit based on characteristics of a heating element that are recorded and stored in the fixing unit.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a fixing unit including a heating element to apply heat to a printing medium to fix a transferred image thereon, a temperature sensor to sense a temperature of the heating element, and a storage medium to store characteristic data of the heating element.

The characteristic data of the heating element may include data regarding resistance values of the heating element according to the temperature of the heating element.

The temperature sensor may include a thermistor.

The foregoing and/or other aspects of the present general inventive concept are also achieved by providing an image forming apparatus including a fixing unit having a heating element to apply heat to a printing paper to fix a transferred image thereon, a temperature sensor to sense temperature of the heating element, and a storage medium to store characteristic data of the heating element, and a controller to read the characteristic data of the heating element and to determine a control mode of the fixing unit based on the characteristic data of the heating element.

The characteristic data of the heating element may include data regarding resistance values of the heating element according to the temperature of the heating element. The controller may periodically receive a temperature sensing signal corresponding to a current temperature of the heating element from the temperature sensor, generate a heating element control signal to maintain the heating element at a predetermined fixing temperature based on the resistance value of the heating element at the current temperature, and transmit the heating element control signal to the heating element.

The temperature sensor may include a thermistor.

The image forming apparatus may further include a plurality of different driving circuits to drive the fixing unit, and a switching unit to select one of the plurality of different driving circuits according to characteristics of the heating element and to connect the fixing unit to the selected driving circuit.

The foregoing and/or other aspects of the present general inventive concept are also achieved by providing a method of controlling a fixing unit including a heating element to apply heat to a printing medium to fix a transferred image thereon, a temperature sensor to sense a temperature of the heating element, and a storage medium to store characteristic data of the heating element. The method includes accessing the fixing unit and reading the characteristic data of the heating element from the storage medium, and setting a control mode of the fixing unit based on the characteristic data of the heating element.

The method may further include periodically detecting a current temperature of the heating element through the temperature sensor, and controlling the heating element to maintain a predetermined fixing temperature based on a resistance value of the heating element at the detected current temperature that is obtained from the characteristic data of the heating element, wherein the characteristic data of the heating element includes data regarding resistance values of the heating element according to the temperature of the heating element.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a sectional view illustrating an image forming apparatus according to an embodiment of the present general inventive concept;

FIG. 2 is a block diagram illustrating a fixing unit and a controller of the image forming apparatus of FIG. 1; and

FIG. 3 is a flowchart of a method of controlling the fixing unit according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

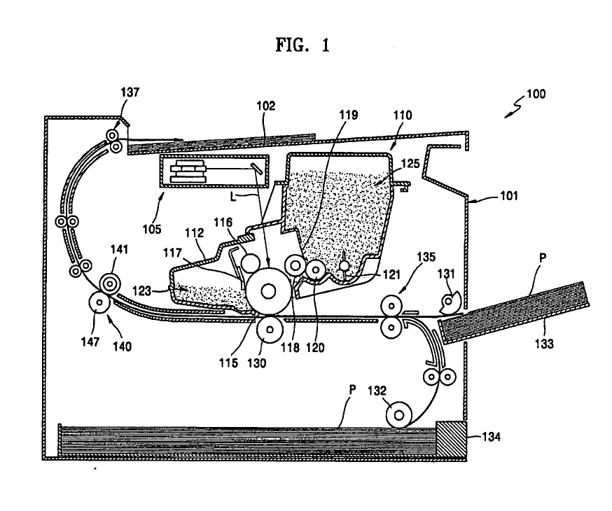

FIG. 1 illustrates an image forming apparatus 100 according to an embodiment of the present general inventive concept. Referring to FIG. 1, the image forming apparatus 100 is an electrophotographic image forming apparatus including a case 101 and a printing unit provided within the case 101. The printing unit includes an optical scanner 105, a developer unit 110, a transfer roller 130, and a fixing unit 140.

The developer unit 110 can be provided in the form of a cartridge that is removably installable within the case 101. The developer unit 110 may include a frame 112 to define an outer appearance thereof and a photosensitive medium 115, a charging roller 116, a waste toner cleaner 117, a developer roller 118, a doctor blade 119, a supply roller 120, and an agitator 121 which are installed within the frame 112. A waste toner space 123, which receives and stores waste toner that is scraped off an outer surface of the photosensitive medium 115 by the waste toner cleaner 117, and a toner reservoir space 125, which contains a developing agent, i.e., toner, are provided within the frame 112. The developer unit 110 can be replaced with a new one when the toner contained in the toner reservoir space 125 is exhausted.

The photosensitive medium 115 can include a photoreceptor drum, which is a photoconductive material layer formed on an outer surface of a cylindrical metal drum using a predetermined process, such as for example, deposition. The photosensitive medium 115 is charged to a predetermined potential by the charging roller 116. An electrostatic latent image corresponding to an image to be printed is formed on the outer surface of the photosensitive medium 115 by light L scanned by the optical scanner 105. The developer roller 118 delivers the developing agent, i.e., the toner, to the photosensitive medium 115 having the electrostatic latent image formed thereon and develops the electrostatic latent image into a visual image. The supply roller 120 supplies the toner to the developer roller 118. The agitator 121 agitates the toner within the toner reservoir space 125 to prevent the toner from hardening and setting at one location. The doctor blade 119 controls a thickness of the toner on an outer surface of the developer roller 118 when the toner is supplied to the developing roller 118 by the supply roller 120. The waste toner cleaner 117 scrapes off the waste toner remaining on the outer surface of the photosensitive medium 115 after the visual image is transferred to a printing medium, such as paper P. The waste toner is scraped off and stored in the waste toner space 123.

The transfer roller 130 is disposed to face the outer surface of the photosensitive medium 115. The visual image formed on the outer surface of the photosensitive medium 115 is transferred to the paper P as the paper P passes between the transfer roller 130 and the photosensitive medium 115 due to transfer bias or contact pressure therebetween.

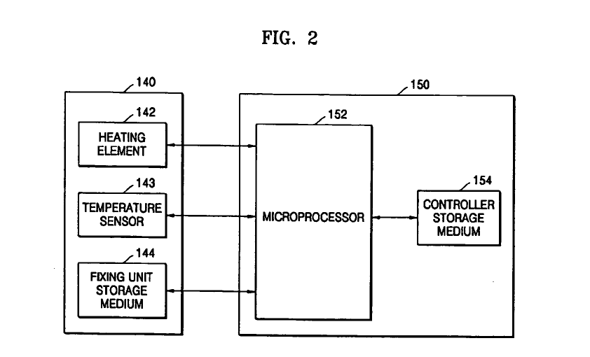

The fixing unit 140 includes a heat roller 141 having a heating element (142 illustrated in FIG. 2) therewithin and a pressure roller 147 facing the heat roller 141. When the paper P having the visual image thereon passes between the heat roller 141 and the pressure roller 147, the visual image is fixed to the paper P due to heat and pressure of the heat roller 141 and the pressure roller 147, respectively.

The image forming apparatus 100 can further include a paper feed tray 133 and a paper feed cassette 134 provided at a lower portion of the case 101, pick-up rollers 131 and 132 to pick up the paper P from the paper feed tray 133 and the paper feed cassette 134, respectively, and a paper aligner 135, which provides a feeding force to the picked-up paper P and aligns the paper P before being passed between the photosensitive medium 115 and the transfer roller 130 such that the visual image is transferred to a predetermined portion of the paper P. The image forming apparatus 100 can also include a discharge roller 137 which discharges the printing paper P, having the visual image fixed thereon, after the paper P passes through the fixing unit 140 to a discharged printing paper support 102 provided at an outer portion of the case 101.

In operations of the electrophotographic image forming apparatus 100, the photosensitive medium 115 is charged to a predetermined potential by the charging roller 116 and reacts to the light L scanned by the optical scanner 105 such that the electrostatic latent image corresponding to the image to be printed is formed on the outer surface of the photosensitive medium 115. The toner in the toner reservoir space 125 within the developer unit 110 is agitated by the agitator 121 and supplied to the photosensitive medium 115 having the electrostatic latent image formed thereon through the supply roller 120 and the developer roller 118. As a result, the visual image is developed on the outer surface of the photosensitive medium 115. Meanwhile, the paper P stacked in the paper feed tray 133 or the paper feed cassette 134 is picked up by the pick-up roller 131 or 132 and fed and aligned by the paper aligner 135. Next when the paper P passes between the photosensitive medium 115 and the transfer roller 130, the visual image developed on the outer surface of the photosensitive medium 115 is transferred to a side of the paper P facing the photosensitive medium 115. The visual image transferred to the paper P is fixed to the paper P due to the heat and the pressure applied by the heat roller 141 and the pressure roller 147, respectively, when the paper P passes through the fixing unit 140. Then, the paper P is discharged by the discharge roller 137 to the discharged paper support 102.

FIG. 2 illustrates an operational configuration of the fixing unit 140 according to an embodiment of the present general inventive concept. Referring to FIG. 2, the fixing unit 140 includes a heating element 142 installed within the heat roller 141 to apply the heat to the paper P, a temperature sensor 143 to sense a temperature of the heating element 142, and a fixing unit storage medium 144 to store characteristic data of the heating element 142.

The heating element 142 can be classified as one of a halogen lamp type heating element, a hot-wire type heating element, and an induction heater (IH) type heating element. Within each of the above types of heating elements, the heating element 142 can be further classified according to an amount of heat generated by the heating element 142, a size of the heating element 142, and a consumption power of the heating element 142. The heating element 142 can be electrically connected to a microprocessor 152 included in a controller 150 of the image forming apparatus 100 (FIG. 1) and is controlled by control signals generated by the microprocessor 152.

The temperature sensor 143 may include a thermistor, which is a semiconductor device used to measure temperature since a resistance of the thermistor changes substantially in response to even a slight change in temperature. The thermistor may be one of a negative temperature coefficient (NTC) thermistor, in which the resistance thereof decreases as temperature increases unlike normal metal, and a positive temperature coefficient (PTC) thermistor. The temperature sensor 143 periodically senses a current temperature of the heating element 142 and transmits a temperature sensing signal to the microprocessor 152.

The characteristic data of the heating element 142 included in the fixing unit 140 is stored in the fixing unit storage medium 144. The characteristic data includes data regarding resistance values of the heating element 142 according to the temperature of the heating element 142. In addition, the characteristic data may further include data regarding the amount of heat generated by the heating element 142, the size of the heating element 142, and/or the consumption power of the heating element 142. The fixing unit storage medium 144 may include a non-volatile memory device to prevent the characteristic data from disappearing when power is cut off. In addition to the characteristics of the heating element 142, device characteristics of the temperature sensor 143 or the fixing unit storage medium 144 may be recorded and stored in the fixing unit storage medium 144. The characteristics of the heating element 142, the temperature sensor 143, and the fixing unit storage medium 144 recorded and stored in the fixing unit storage medium 144 are data used by the controller 150 to recognize a type of the fixing unit 140. A type of characteristic stored in the fixing unit storage medium 144 can be determined by standardization between providers of the fixing unit 140 and providers of the image forming apparatus 100.

The controller 150 of the image forming apparatus 100 reads the characteristic data of the heating element 142 from the fixing unit storage medium 144 and determines a control mode of the fixing unit 140 based on the characteristic data. The controller 150 includes the microprocessor 152, which can be electrically connected with the heating element 142, the temperature sensor 143, and the fixing unit storage medium 144 and a controller storage medium 154 electrically connected with the microprocessor 152. The microprocessor 152 can alternatively communicate with the heating element 142 by other means, such as a wireless communication.

The controller storage medium 154 stores a plurality of control modes corresponding to different types of fixing units 140 which can be used with the image forming apparatus 100. Each control mode includes control information needed to control the heating element 142. The control information may include a numerical expression needed by the microprocessor 152 to generate a control signal to maintain the heating element 142 at a predetermined fixing temperature. Alternatively, the control information may include heating element control signal data needed to maintain the heating element 142 at the predetermined fixing temperature without computation of the microprocessor 152.

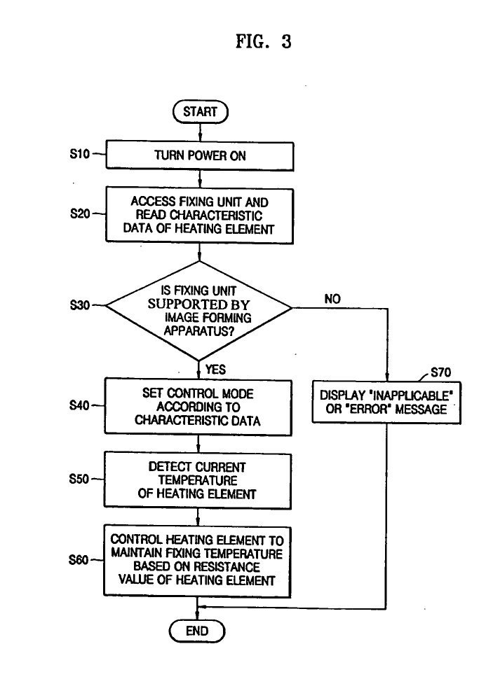

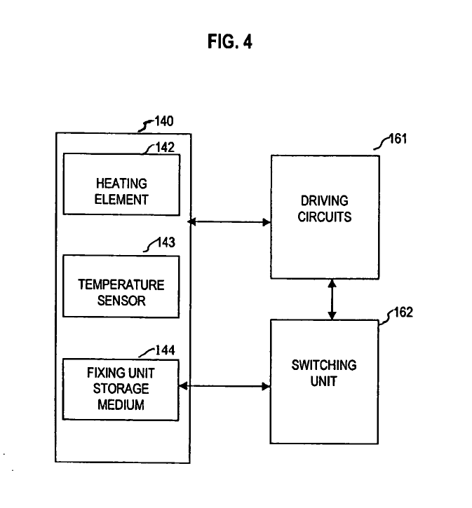

FIG. 3 illustrates a method of controlling the fixing unit 140 using the controller 150 according to an embodiment of the present general inventive concept.

Referring to FIG. 3, at operation S10, power is turned on after the fixing unit 140 is installed in the image forming apparatus 100. Then, at operation S20, the controller 150 accesses the fixing unit 140 and reads the characteristic data of the heating element 142 from the fixing unit storage medium 144. At operation S30, the microprocessor 152 recognizes the type of the fixing unit 140 based on the characteristic data read from the fixing unit storage medium 144 and determines whether the fixing unit 140 is supported by the image forming apparatus 100. If the characteristics of the temperature sensor 143 or the fixing unit storage medium 144 are additionally stored in the fixing unit storage medium 144, they can also be used or alternatively be used to recognize the type of the fixing unit 140. In other words, the characteristics of any of the heating element 142, the temperature sensor 143, or the fixing unit storage medium 144 can be used to recognize the type of the fixing unit 140.

If the fixing unit 140 is not a type supported by the image forming apparatus 100, the controller 150 controls a display unit (not shown), such as a liquid crystal display (LCD) provided an outer surface of the case 101 to display an “Inapplicable” or “Error” message at operation S70. However, if the fixing unit 140 is a type supported by the image forming apparatus 100, the controller 150 determines a control mode of the fixing unit 140 based on the characteristic data of the heating element 142 at operation S40. For example, a control mode most suitable to the type of fixing unit 140 that is recognized by the microprocessor 152 based on the characteristic data of the heating element 142 may be selected from the plurality of control modes stored in the controller storage medium 154.

The controller 150 controls the fixing unit 140 according to the control mode. An object of the control may be, for example, a warming-up time or a fixing temperature. When the fixing temperature is the object of the control, a detailed control procedure performed by the controller 150 is as follows.

At operation S50, the controller 150 periodically receives the temperature sensing signal from the temperature sensor 143 and detects the current temperature of the heating element 142 based on the temperature sensing signal. At operation S60, the controller 150 recognizes the resistance value of the heating element 142 at the current temperature from the data regarding resistance values of the heating element 142, which is included in the characteristic data of the heating element 142, and controls the heating element 142 to maintain the predetermined fixing temperature based on the recognized resistance value.

More specifically, when the control information included in the control mode is the numerical expression needed to generate the heating element control signal to maintain the heating element 142 at the predetermined fixing temperature, the microprocessor 152 retrieves the numerical expression from the controller storage medium 154 and applies the resistance value of the heating element 142 at the current temperature to the numerical expression, thereby generating the heating element control signal. The heating element control signal is transmitted to the heating element 142 to maintain the heating element 142 at the predetermined fixing temperature.

Alternatively, when the control information included in the control mode is the heating element control signal data, the microprocessor 152 retrieves the heating element control signal data from the controller storage medium 154 and selects a heating element control signal corresponding to the resistance value of the heating element 142 at the current temperature. The selected heating element control signal is transmitted to the heating element 142 to maintain the heating element 142 at the predetermined fixing temperature.

FIG. 4 illustrates an operational configuration of an image forming apparatus according to an embodiment of the present general inventive concept. A driving circuit for some types of fixing units may not be shared. To manage these types of fixing units, an image forming apparatus, as illustrated in FIG. 4, may include a plurality of driving circuits 161 and a switching unit 162 that selects one of the plurality of driving circuits 161 according to characteristics of a heating element 142 of a fixing unit 140 stored in a fixing unit storage medium 144 and connects the selected one of the plurality of driving circuits 161 to the fixing unit 140. In this case, the plurality of driving circuits 161 and the switching unit 162 may be included in a controller of the image forming apparatus, and the controller can set a control mode based on the characteristics of the heating element 142, and control the switching unit 162 to connect the fixing unit 140 to one of the plurality driving circuits 161 most suitable to the fixing unit 140. In addition, the controller may determine whether the fixing unit 140 is supported by the image forming apparatus based on the suitability of the plurality of driving circuits 161 with respect to the fixing unit 140.

According to the embodiments of present general inventive concept, various types of fixing units can be installed and used in an image forming apparatus to print images. In addition, since optimal control can be performed according to a type of fixing unit, printing quality increases. The embodiments of present general inventive concept also allow a user to select a fixing unit having desired fixing characteristics when there are fixing units having different fixing characteristics in, for example, preheating speed, fixing temperature, and consumption power. Since a fixing unit initially installed in an image forming apparatus can be replaced with a different type of fixing unit, the image forming apparatus can be continuously used even when the same type of fixing unit as that initially installed cannot be obtained due to sold-out or out-of-stock situations. As a result, waste of resources can be decreased and waste can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A fixing unit comprising:
a heating element to apply heat to a printing medium to fix a transferred image thereon;
a temperature sensor to sense a temperature of the heating element; and
a storage medium to store characteristic data of the heating element.

2. The fixing unit of claim 1, wherein the characteristic data of the heating element comprises data regarding resistance values of the heating element according to the temperature of the heating element.

3. The fixing unit of claim 1, wherein the temperature sensor comprises a thermistor.

4. The fixing unit of claim 1, wherein the storage medium further stores characteristic data of at least one of the temperature sensor and the storage medium.

5. A fixing unit usable with an image forming apparatus, comprising:
a heating element to apply heat to a printing medium; and
a storage medium readable by the image forming apparatus to store characteristic data of the type of the heating element and/or the fixing unit.

6. The fixing unit of claim 5, further comprising:
a temperature sensor to sense a temperature of the heating element and to transmit the sensed temperature to the image forming apparatus.

7. The fixing unit of claim 5, further comprising:
a heat roller having the heating element provided therein to transfer the printing medium while the heating element applies the heat to the printing medium.

8. An image forming apparatus comprising:
a fixing unit comprising a heating element to apply heat to a printing medium to fix a transferred image thereon, a temperature sensor to sense a temperature of the heating element, and a storage medium to store characteristic data of the heating element; and
a controller to read the characteristic data of the heating element and to determine a control mode of the fixing unit based on the characteristic data of the heating element.

9. The image forming apparatus of claim 8, wherein the characteristic data of the heating element comprises data regarding resistance values of the heating element according to the temperature of the heating element, and
the controller periodically receives a temperature sensing signal corresponding to a current temperature of the heating element from the temperature sensor, generates a heating element control signal to maintain the heating element at a predetermined fixing temperature based on the resistance value of the heating element at the current temperature, and transmits the heating element control signal to the heating element.

10. The image forming apparatus of claim 8, wherein the temperature sensor comprises a thermistor.

11. The image forming apparatus of claim 8, further comprising:
a plurality of different driving circuits to divide the fixing unit; and
a switching unit to select one driving circuit from among the plurality of different driving circuits according to characteristic data of the heating element and to connect the fixing unit to the selected driving circuit.

12. The image forming apparatus of claim 8, wherein the controller comprises:
a controller storage medium to store a plurality of control modes; and
a microprocessor to read the characteristic data and to select one of the plurality of control modes stored in the controller storage medium according to the characteristic data.

13. An image forming apparatus compatible with a plurality of types of fixing units each having a storage medium to store characteristic information therein, the image forming apparatus comprising:
a controller storage medium to store a plurality of control modes therein;
a microprocessor to read the characteristic information from a fixing unit to determine the type of fixing unit installed therein, to select one of the plurality of control modes according to the determined type of fixing unit, and to control the fixing unit according to the selected one of the plurality of control modes.

14. The image forming apparatus of claim 13, wherein each of the plurality of control modes includes control information and the microprocessor controls the fixing unit installed therein according to the control information of the selected control mode and the characteristic information read from the fixing unit.

15. The image forming apparatus of claim 13, wherein the microprocessor receives condition signals from the fixing unit regarding current conditions of the fixing unit and controls the fixing unit according to the received condition signals and the selected control mode.

16. The image forming apparatus of claim 13, further comprising:
a plurality of driving circuits corresponding the plurality of types of fixing units; and
a switching unit to select a compatible one of the plurality of driving units to drive the fixing unit according to the characteristic information of the fixing unit.

17. The image forming apparatus of claim 16, wherein when none of the plurality of driving circuits is compatible with the fixing unit, the microprocessor determines that the fixing unit is not supported by the image forming apparatus.

18. A method of controlling a fixing unit including a heating element to apply heat to a printing medium to fix a transferred image thereon, a temperature sensor to sense a temperature of the heating element, and a storage medium to store characteristic data of the heating element, the method comprising:
accessing the fixing unit and reading the characteristic data of the heating element from the storage medium; and
setting a control mode of the fixing unit based on the characteristic data of the heating element.

19. The method of claim 18, further comprising:
periodically detecting a current temperature of the heating element through the temperature sensor; and
controlling the heating element to maintain a predetermined fixing temperature based on a resistance value of the heating element at the detected current temperature that is obtained from the characteristic data of the heating element,
wherein the characteristic data of the heating element comprises data regarding resistance values of the heating element according to the temperature of the heating element.

20. The method of claim 19 wherein the controlling of the heating element comprises:
retrieving a stored numerical expression;
applying the resistance value of the heating element at the detected current temperature to the retrieved numerical expression to generate a control signal; and
transmitting the generated control signal to the heating element.

21. The method of claim 19, wherein the controlling of the heating element comprises:
selecting a stored control signal according to the resistance value of the heating element at the detected temperature; and
transmitting the selected control signal to the heating element.

22. The method of claim 18, further comprising:
controlling the heating element of the fixing unit according to the set control mode to apply the heat to the printing medium.

23. A method of controlling a fixing unit installed in an image forming apparatus, the method comprising:
determining whether the fixing unit is supported by the image forming apparatus according to characteristic information stored in the fixing unit; and
controlling the fixing unit according to the characteristic information when the fixing unit is determined to be supported by the image forming apparatus.

24. The method of claim 23, wherein the determining of whether the fixing unit is supported by the image forming apparatus comprises:
determining whether any of a plurality of driving circuits of the image forming apparatus are compatible with the fixing unit according to the characteristic information.

25. The method of claim 24, wherein the controlling of the fixing unit, comprises:
driving the fixing unit with a compatible one of the plurality of driving circuits.

26. The method of claim 23, wherein the controlling of the fixing unit comprises:
controlling one of a warm-up time and a fixing temperature of the fixing unit based on the characteristic information.

27. The method of claim 23, further comprising:
displaying an error message on a display of the image forming apparatus when the fixing unit is not supported by the image forming apparatus.
